(19) United States
(12) Patent Application Publication
(10) Pub. No.: US 2011/0193308 A1
(43) Pub. Date: Aug. 11, 2011

(54) 3 wheeled motorcycle with countersteer

(76) Inventor: Roger Dale Plumley, Crab Orchard, WV (US)

(21) Appl. No.: 13/066,207

(22) Filed: Apr. 11, 2011

Related U.S. Application Data
(63) Continuation of application No. 12/284,089, filed on Sep. 19, 2008, now abandoned.

(51) Int. Cl. B60G 21/00

(52) U.S. Cl. 280/124.103

(57) ABSTRACT

A 3 wheeled motorcycle in which the vertical axis of all 3 wheels remains parallel, capable of counter-steer/lean when making a turn.

### BACKGROUND

Steering of a motorcycle (and bicycle) is accomplished with counter-steer (I.E. turning front wheel in opposite direction of desired turn.) at speeds above 3 mph. Interaction of off-set in steering axis, rake angle, and trail in steering geometry affect this phenomenon. As counter-steer action takes place in a turn, the wheels and motorcycle lean to the side in the direction of the turn. The rider instinctively leans in the same direction as the motorcycle to overcome centrifugal forces caused by the turn. A paper titled “Steering in Bicycles and Motorcycles” by J. Fajans better explains this phenomenon. A copy of this paper has been included with this patent application as prior art.

In prior 3 wheeled motorcycles, the front and rear wheel vertical axis has been fixed, perpendicular to the motorcycle frame and perpendicular to the roadway surface. This fixed relationship causes a tendency to over-turn the motorcycle, due to centrifugal force, when making a “tricycle” type turn.

### SUMMARY OF INVENTION

It is the object of this invention to provide the ability to counter-steer and lean with all 3 wheels as is done with a conventional 2 wheel motorcycle.

The rear wheel transmission is rigidly mounted to the motorcycle frame and rotatibly mounted to the leaf spring assembly. The ends of the leaf spring assembly are rotatibly mounted to the rear wheel backing plates. Therefore, a lean of the motorcycle frame and rear wheel transmission causes a rotation at the leaf spring rotatable mount point. Lower control arms are rotatibly mounted to the rear wheel transmission and the rear wheel backing plates, thereby a leaning of the motorcycle frame and rear wheel transmission sets up motion to simulate a stable parallelogram at all times.

The load carrying leaf spring rotatable mounting point is above the center of gravity of the motorcycle and rear wheel transmission. Therefore, with the removal of steering effort, the unit will self center to straight ahead/vertical position. (I.E.—pendulum effect.)

### BRIEF DESCRIPTION OF DRAWINGS

FIG. 1A Diagram illustrating counter-steer

FIG. 1B Diagram illustrating offset in steering axis, trail and rake angle

FIG. 1C Diagram illustrating ground contact—straight ahead

FIG. 1D Diagram illustrating ground contact—leaning right

FIG. 1E Diagram illustrating ground contact—leaning left

FIG. 2A Diagram illustrating present invention—straight ahead

FIG. 2B Diagram illustrating present invention—leaning right

FIG. 3A Top view of present invention

FIG. 3B Rear view of present invention

FIG. 3C Side view of present invention

FIG. 4A Rear view of present invention in straight ahead position

FIG. 4B Rear view of present invention in leaning right position

FIG. 5A Rear view of present invention in extreme left leaning position

FIG. 5B Rear view of present invention in extreme right leaning position

FIG. 6 Top view of present invention with body sheet metal omitted

FIG. 7 Section view taken at cutting plane 7-7 (See FIG. 6)

FIG. 8 Side view of present invention with body sheet metal omitted

FIG. 9 Section view taken at cutting plane 9-9 (See FIG. 8)—smooth road surface

FIG. 10 Section view taken at cutting plane 10-10 (See FIG. 8)—irregular road surface

FIG. 11 Side view—rear wheel transmission

FIG. 12 Top view—rear wheel transmission

FIG. 13 Section view taken at cutting plane 13-13 (See FIG. 11)

FIG. 14 Section view taken at cutting plane 14-14 (See FIG. 7)

FIG. 15 Section view taken at cutting plane 15-15 (See FIG. 7)

FIG. 16A Section view (top) of lower control arm assembly

FIG. 16B Section view (rear) of lower control arm assembly

FIG. 17A Top view of leaf spring assembly

FIG. 17B Rear view of leaf spring assembly

FIG. 18 Side view of present invention

FIG. 19 Section view taken at cutting plane 19-19 (See FIGS. 13 & 18)

FIG. 20 Section view taken at cutting plane 20-20 (See FIGS. 13 & 18)

FIG. 21 Section view taken at cutting plane 21-21 (See FIGS. 13 & 18)

FIG. 22 Section view taken at cutting plane 22-22 (See FIGS. 13 & 18)

FIG. 23 Section view taken at cutting plane 23-23 (See FIGS. 13 & 18)

FIG. 24 Section view taken at cutting plane 24-24 (See FIGS. 13 & 18)

### DETAILED DESCRIPTION OF DRAWINGS

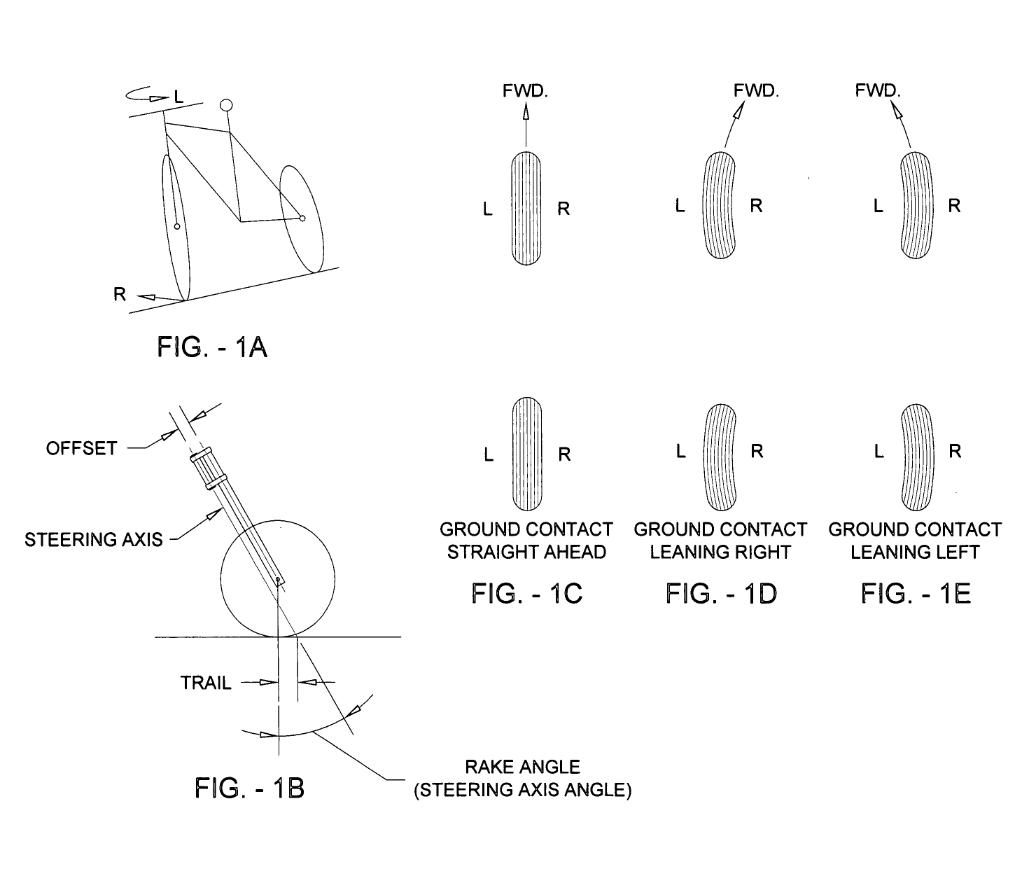

FIG. 1A Diagram illustrating counter-steer

A schematic diagram is shown illustrating a counter clockwise rotation of the steering axis (left hand rotation) causing a counter-steer reaction for a right hand turn.

FIG. 1B Diagram illustrating offset in steering axis, trail and rake angle

Steering axis offset, trail and rake angle (steering axis angle) are shown.

FIG. 1C Diagram illustrating ground contact—straight ahead

A schematic diagram is shown illustrating ground contact of 2 tires in straight ahead condition.

FIG. 1D Diagram illustrating ground contact—leaning right

A schematic diagram is shown illustrating ground contact of 2 tires in leaning right condition.

FIG. 1E Diagram illustrating ground contact—leaning left

A schematic diagram is shown illustrating ground contact of 2 tires in leaning left condition.

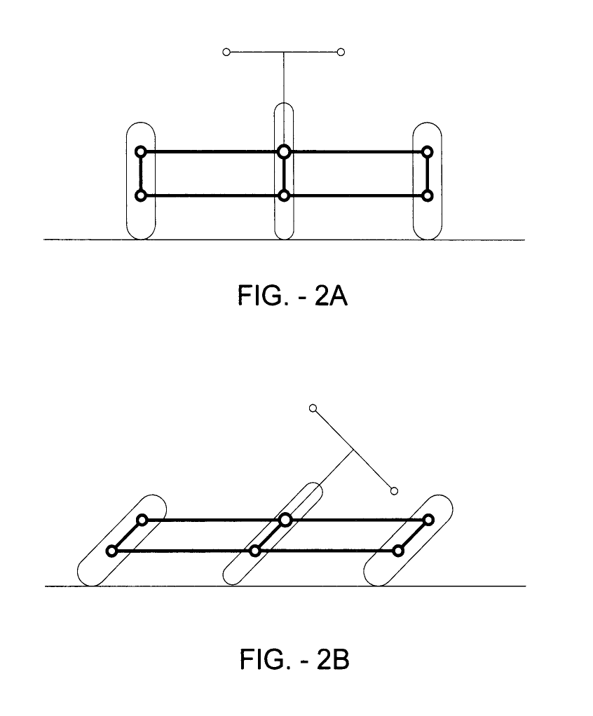

FIG. 2A Diagram illustrating present invention—straight ahead

A schematic diagram is shown illustrating present invention in straight ahead (vertical) position.

FIG. 2B Diagram illustrating present invention—leaning right

A schematic diagram is shown illustrating present invention in leaning right position (right hand turn). Mechanism rotatable connections are such that a double parallelogram is maintained in all circumstances.

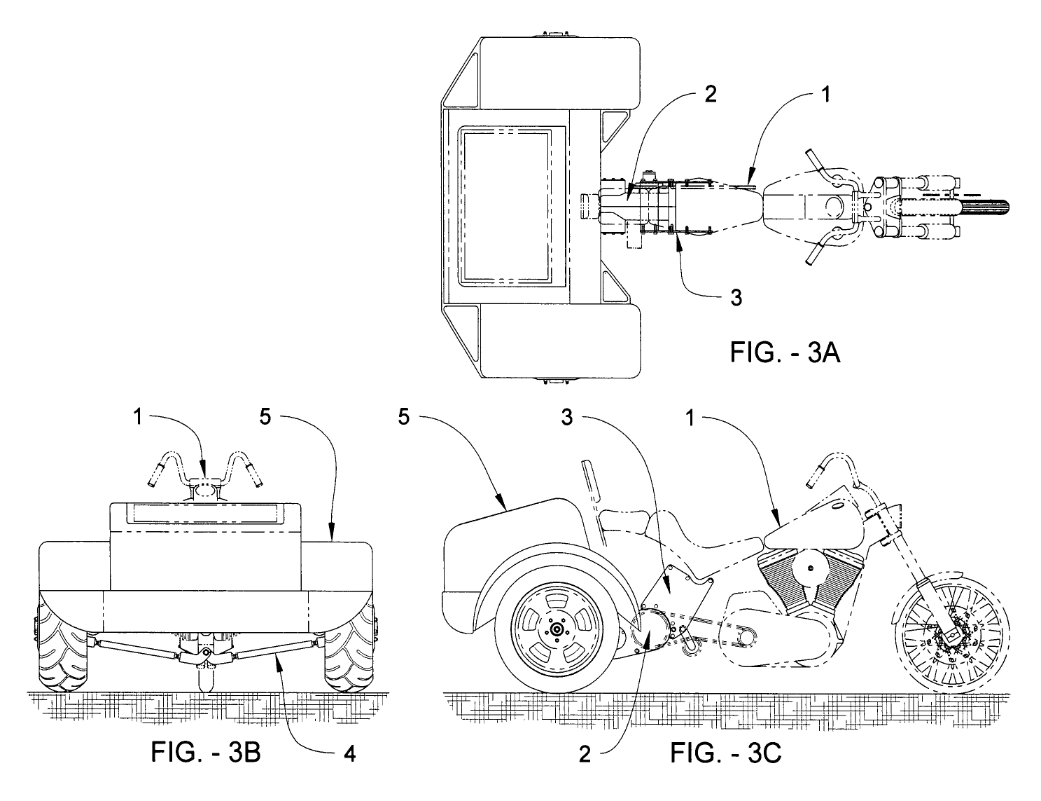

FIG. 3A Top view of present invention

Motorcycle/frame (1) is rigidly connected to rear wheel transmission (2) utilizing connection plates (3).

FIG. 3B Rear view of present invention

Axis of motorcycle/frame (1) and rear wheels (6) remain parallel to each other. Rear body (5) remains parallel to road surface.

FIG. 3C Side view of present invention

Motorcycle/frame (1) is rigidly connected to rear wheel transmission (2) utilizing connection plates (3).

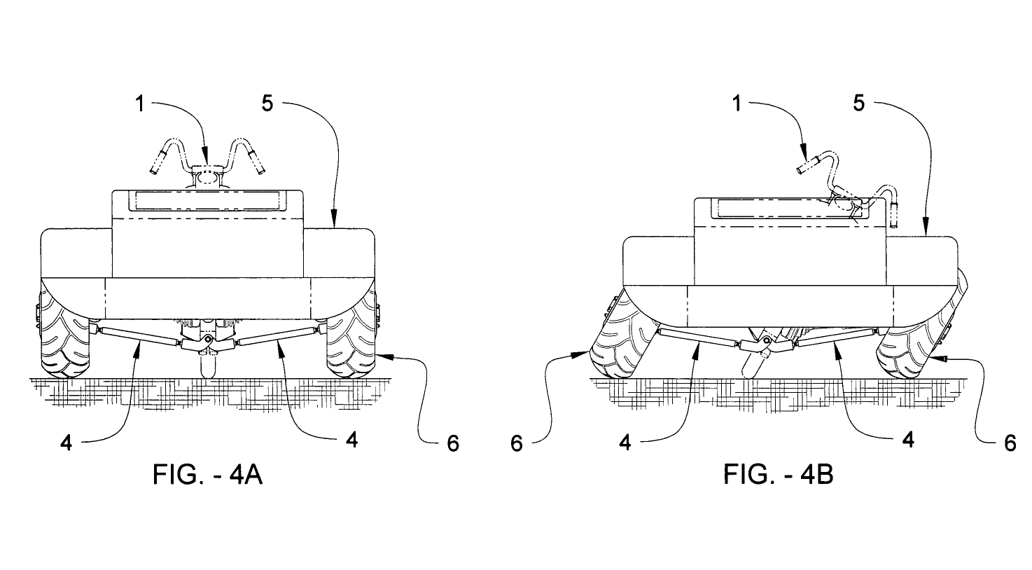

FIG. 4A Rear view of present invention in straight ahead position

Axis of motorcycle/frame (1) and rear wheels (6) remain parallel to each other. Rear body (5) remains parallel to road surface.

FIG. 4B Rear view of present invention in leaning right position

Axis of motorcycle/frame (1) and rear wheels (6) remain parallel to each other. Rear body (5) remains parallel to road surface.

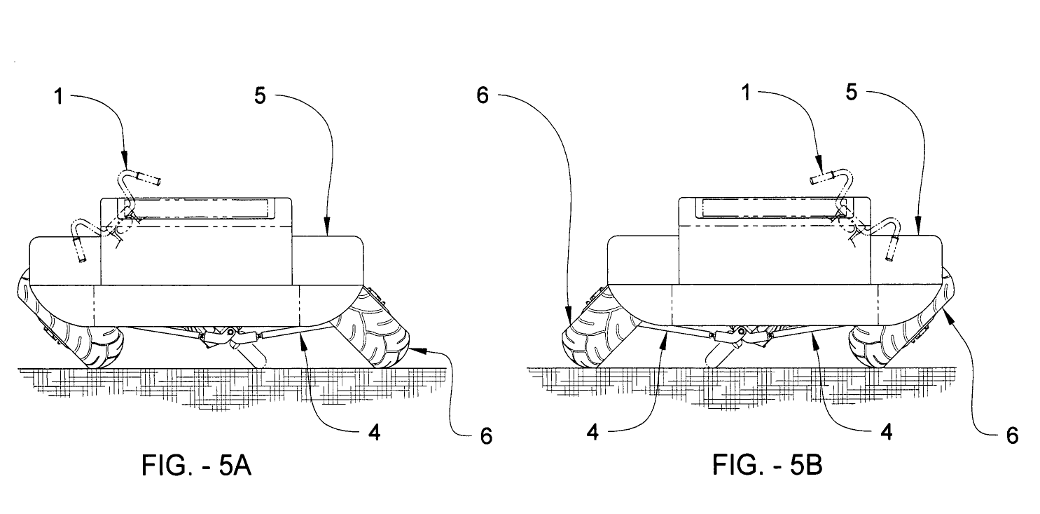

FIG. 5A Rear view of present invention in extreme left leaning position

Axis of motorcycle/frame (1) and rear wheels (6) remain parallel to each other. Rear body (5) remains parallel to road surface.

FIG. 5B Rear view of present invention in extreme right leaning position

Axis of motorcycle/frame (1) and rear wheels (6) remain parallel to each other. Rear body (5) remains parallel to road surface.

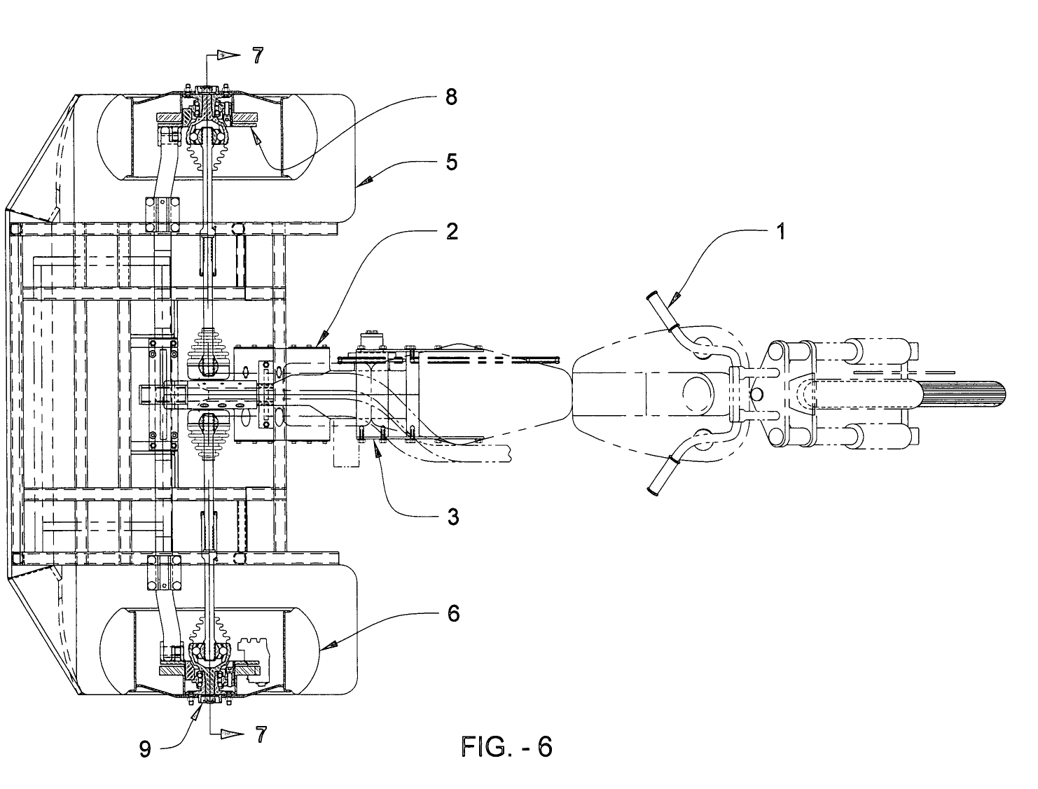

FIG. 6 Top view of present invention with body sheet metal omitted

Motorcycle/frame (1) is rigidly connected to rear wheel transmission (2) utilizing connection plates (3). Rear wheel transmission (2) is rotatably connected to leaf spring assembly (7). Leaf spring assembly (7) is rotatably connected to rear wheel backing plates (8). Rear wheels (6) are rotatably connected to rear wheel backing plates (8) via hubs (9).

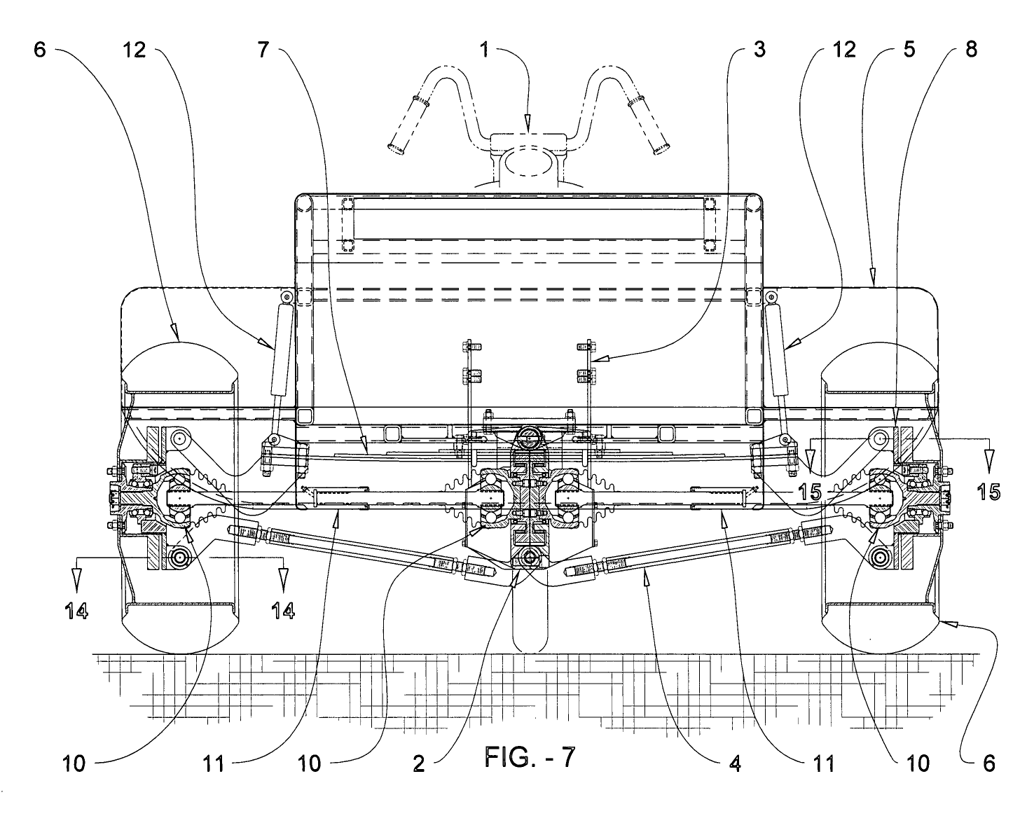

FIG. 7 Section view taken at cutting plane 7-7 (See FIG. 6)

Rear wheel transmission (2) is rotatably connected to hubs (9) via constant velocity joints (10) and telescopic drive shafts (11). Rear wheel transmission (2) is rotatably connected to rear wheel backing plates (8) via lower control arms (4). Shock absorbers (12) are provided between rear body (5) and leaf spring assembly (7) to dampen oscillation of vertical movement.

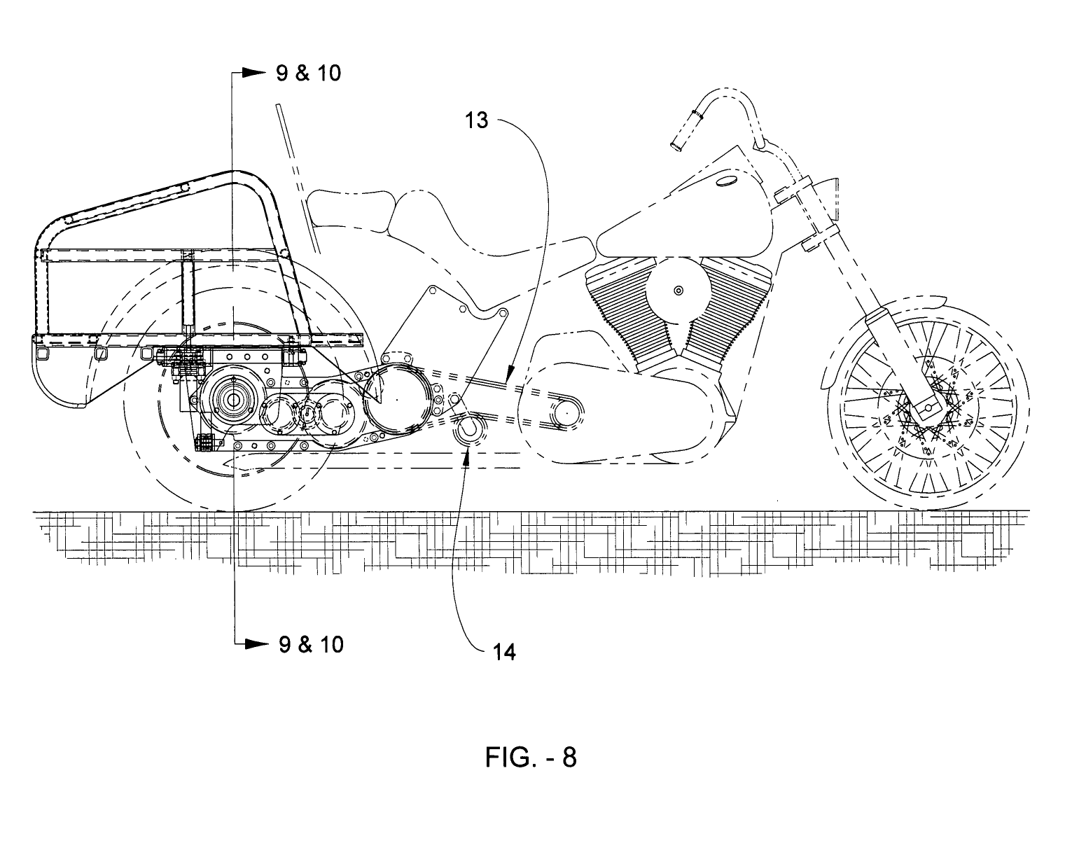

FIG. 8 Side view of present invention with body sheet metal omitted

Chain or belt (13) transmits power from motorcycle/frame to rear wheel transmission (2). Adjustable idler (14) provides an adjustment of slack due to wear.

An obvious variation of this drive would be to adapt to a rotating drive shaft and providing a right angle gear set to accommodate this.

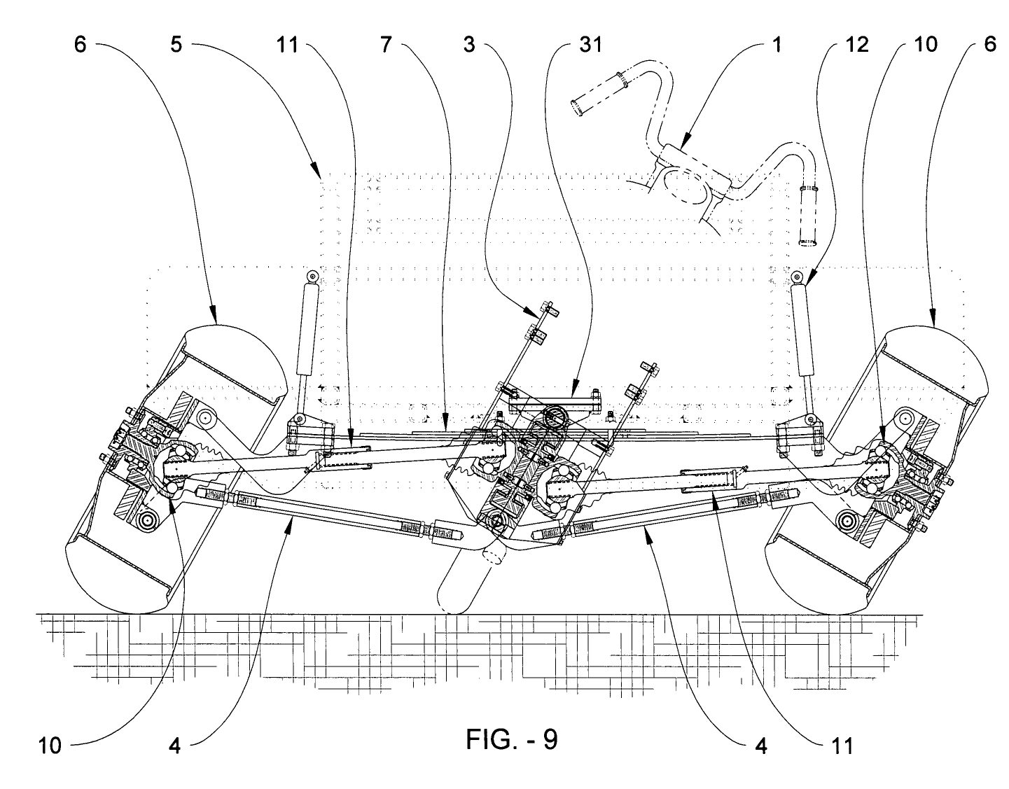

FIG. 9 Section view taken at cutting plane 9-9 (See FIG. 8)—smooth road surface

Rear body (5) is rotatably connected to rear wheel transmission (2) via front mounting bracket (31).

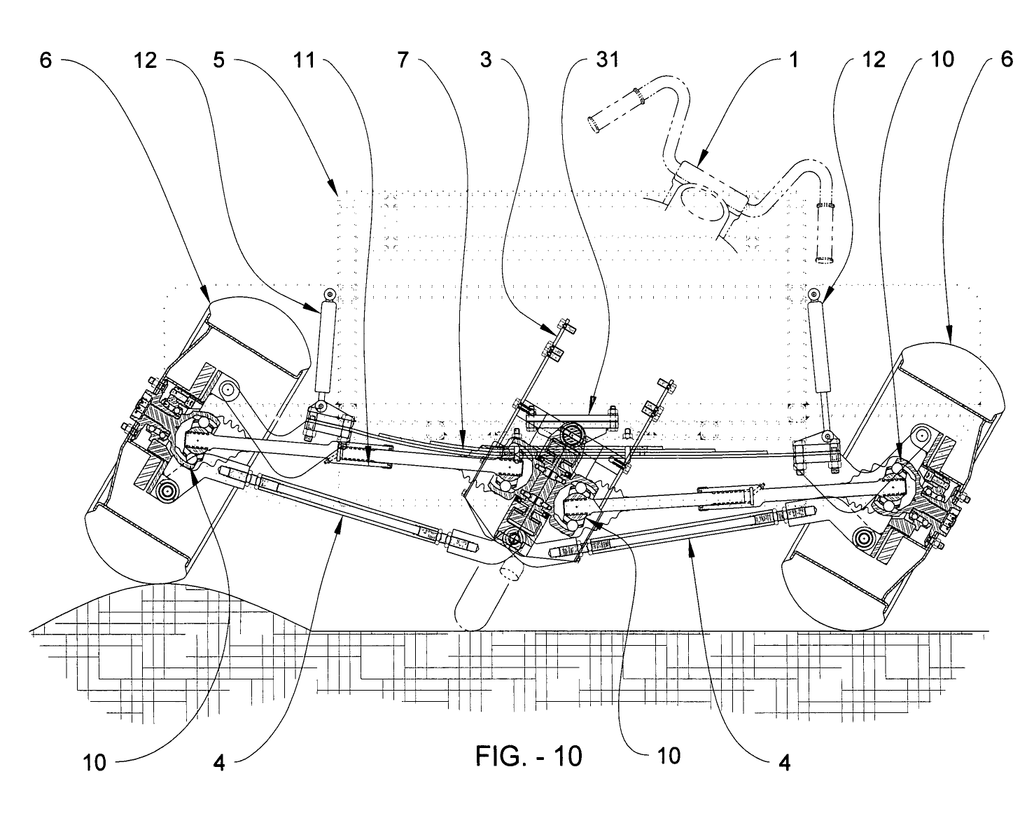

FIG. 10 Section view taken at cutting plane 10-10 (See FIG. 8)—irregular road surface

One rear wheel (6) passes over an irregularity in the road surface causing a deflection in leaf spring assembly (7). This up/down motion is dampened by shock absorbers (12) connected between rear body (5) and the leaf spring assembly (7).

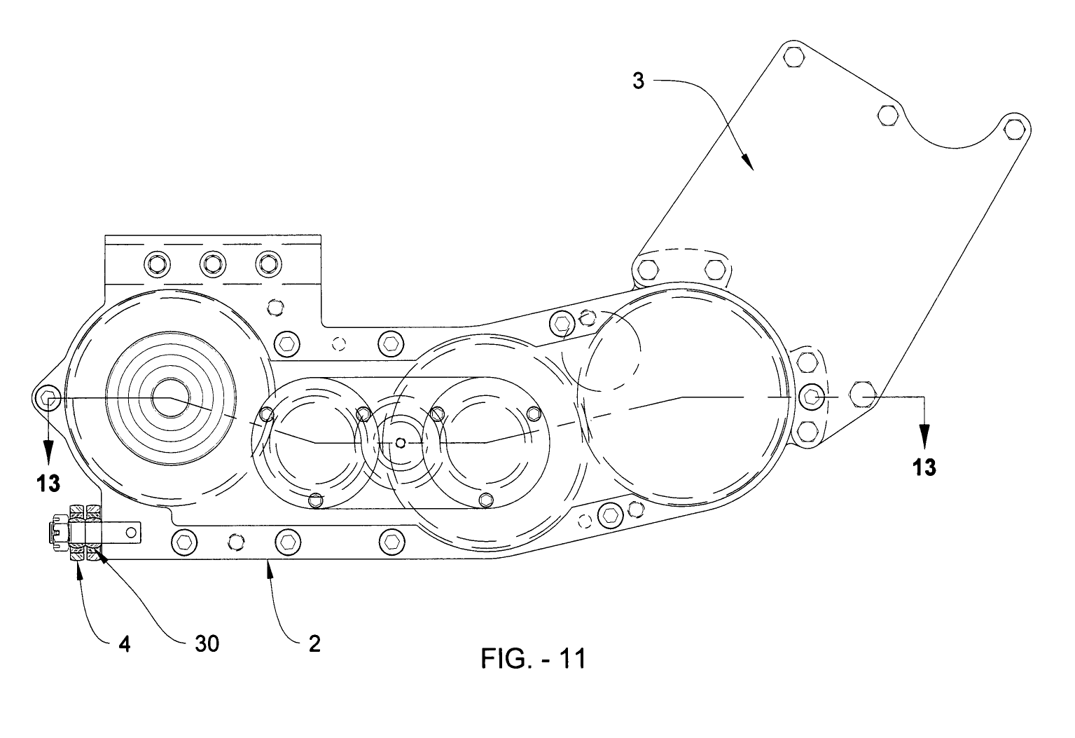

FIG. 11 Side view—rear wheel transmission

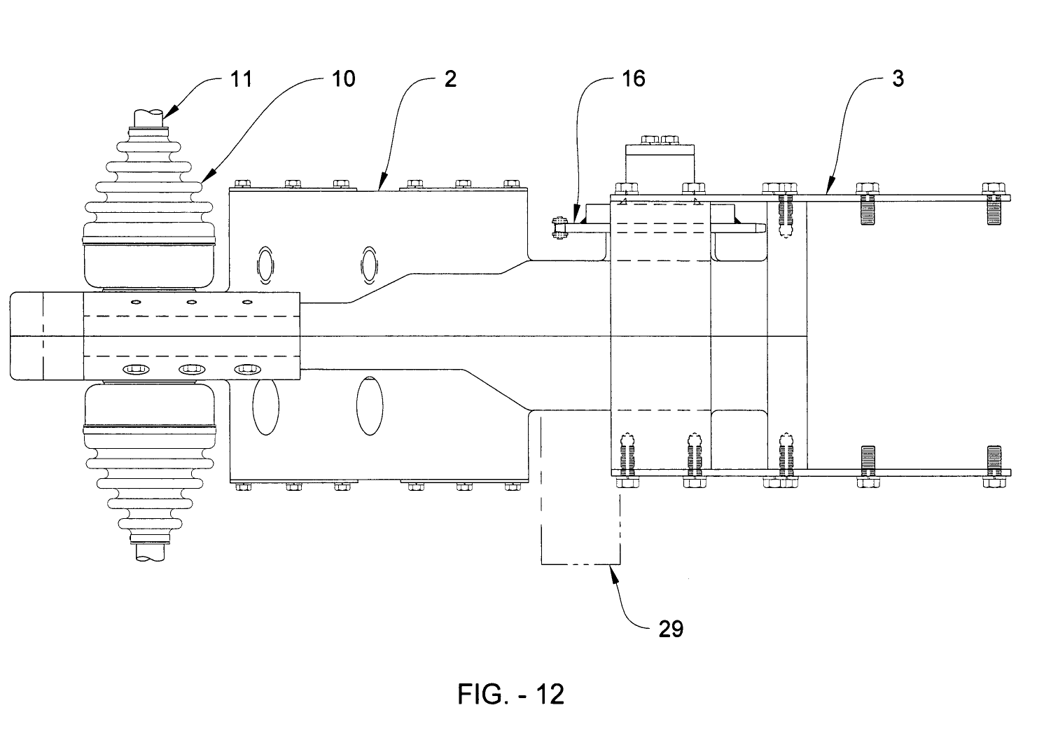

FIG. 12 Top view—rear wheel transmission

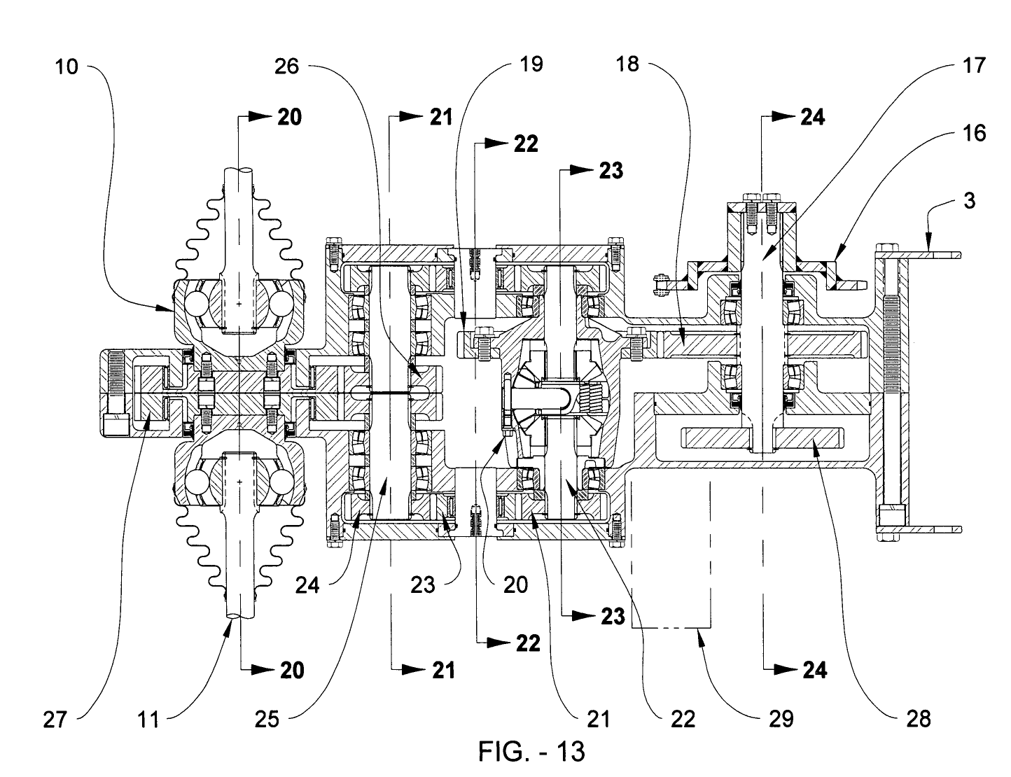

FIG. 13 Section view taken at cutting plane 13-13 (See FIG. 11)

Input shaft (17) is splined to gear (18) and input sprocket (16). Gear (18) drives gear (19) which is mounted onto differential assembly (20). Output of differential assembly (20) is splined to shaft (22) which is splined to gear (21). Gear (21) drives idler gear (23) which drives gear (24). Gear (24) is splined to shaft (25). Shaft (25) is splined to gear (26). Gear (26) drives output gear (27). Output gear (27) is rigidly connected to constant velocity joint (10). Constant velocity joint (10) is splined to telescopic drive shaft (11). Power flow from the differential is duplicated left side and right side to retain differential action.

An obvious variation of this drive would be to adapt to a rotating drive shaft, rather than a chain or belt drive, and providing a right angle gear set to accommodate this.

Electric motor (29) is provided with a solenoid actuated pinion to engage with gear (28) to provide an electric reverse drive when desired.

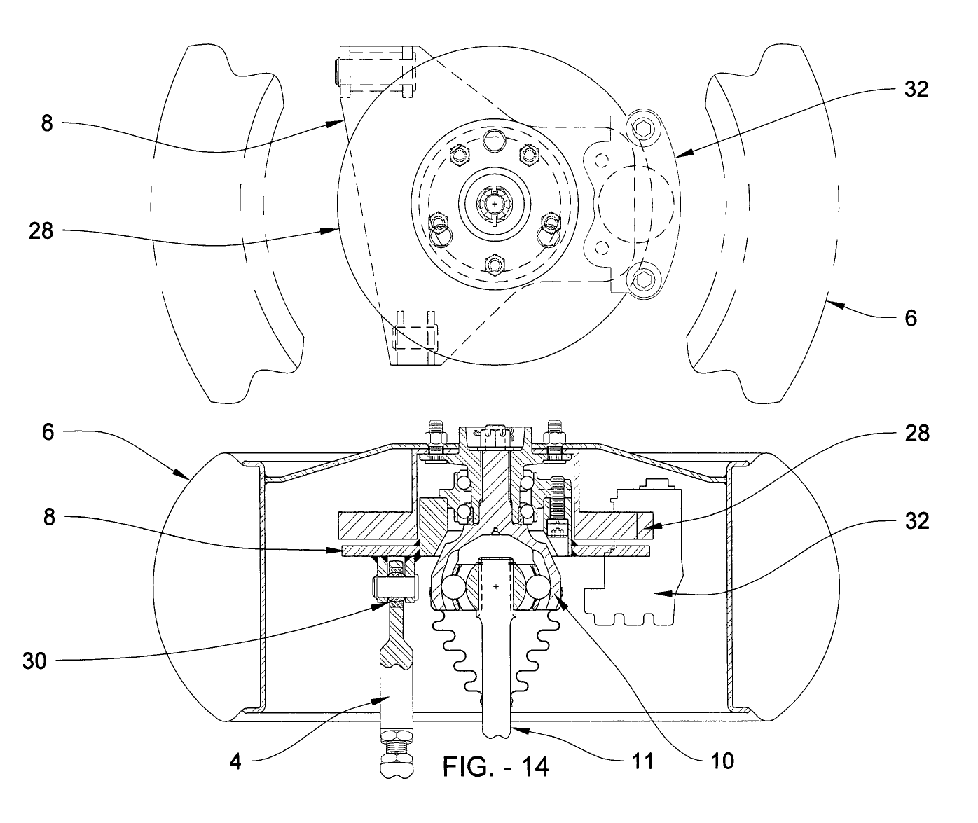

FIG. 14 Section view taken at cutting plane 14-14 (See FIG. 7)

Hub (9) rigidly mounts onto wheel backing plate (8). Brake disc (28) and wheel (6) rigidly mount onto hub (9). Brake caliper (32) mounts onto wheel backing plate (8). Lower control arm (4) is rotatably connected to wheel backing plate (8) via spherical ball bushing (30).

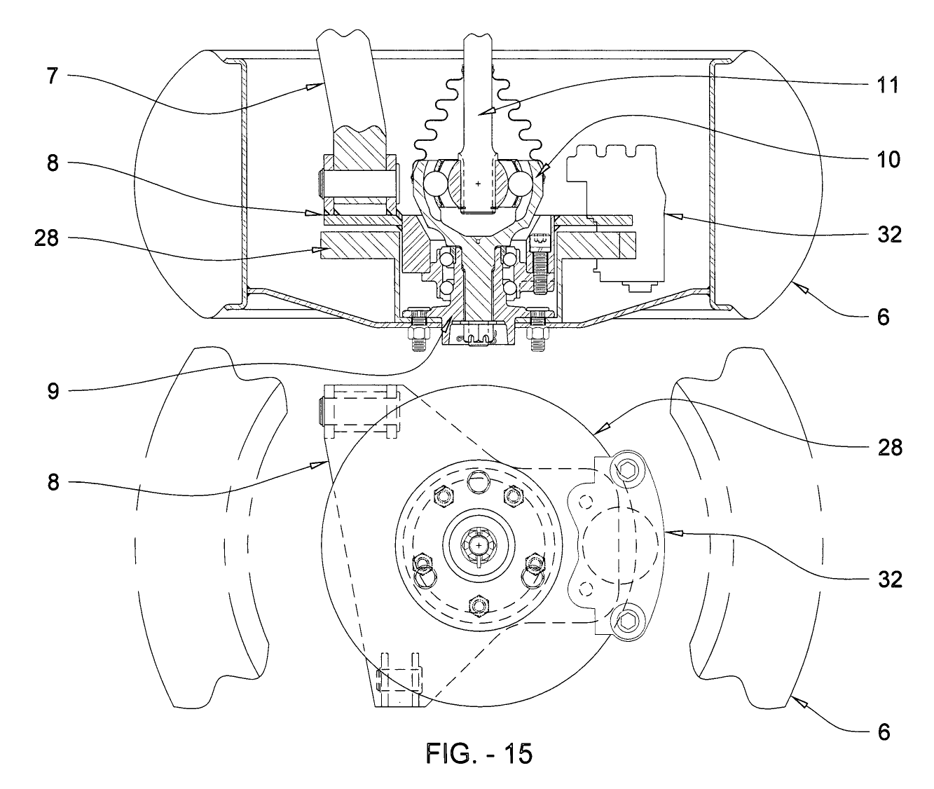

FIG. 15 Section view taken at cutting plane 15-15 (See FIG. 7)

Hub (9) rigidly mounts onto wheel backing plate (8). Brake disc (28) and wheel (6) rigidly mount onto hub (9). Brake caliper (32) mounts onto wheel backing plate (8). Leaf spring assembly (7) rotatably mounts to wheel backing plate (8).

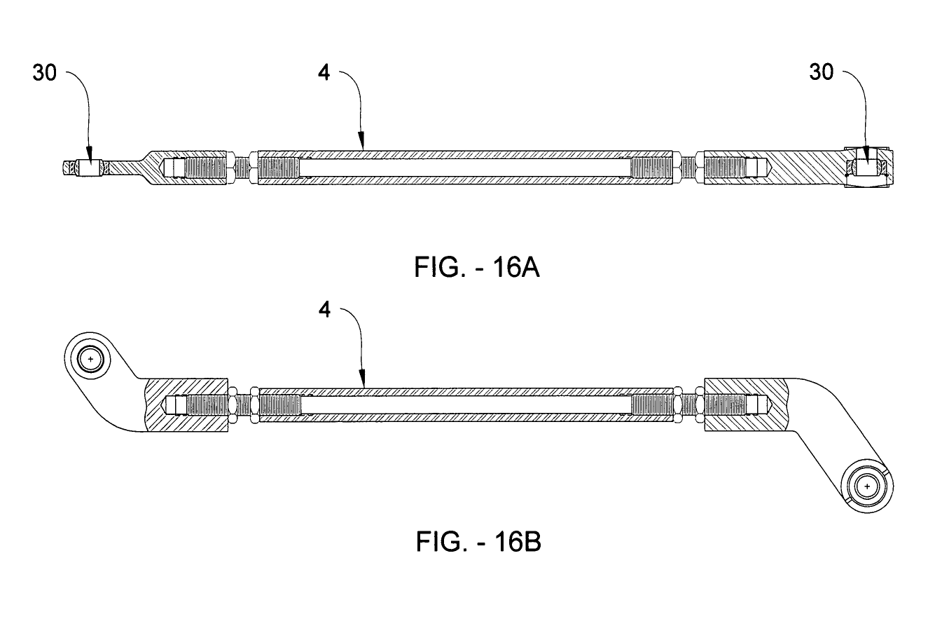

FIG. 16A Section view (top) of lower control arm assembly

FIG. 16B Section view (rear) of lower control arm assembly

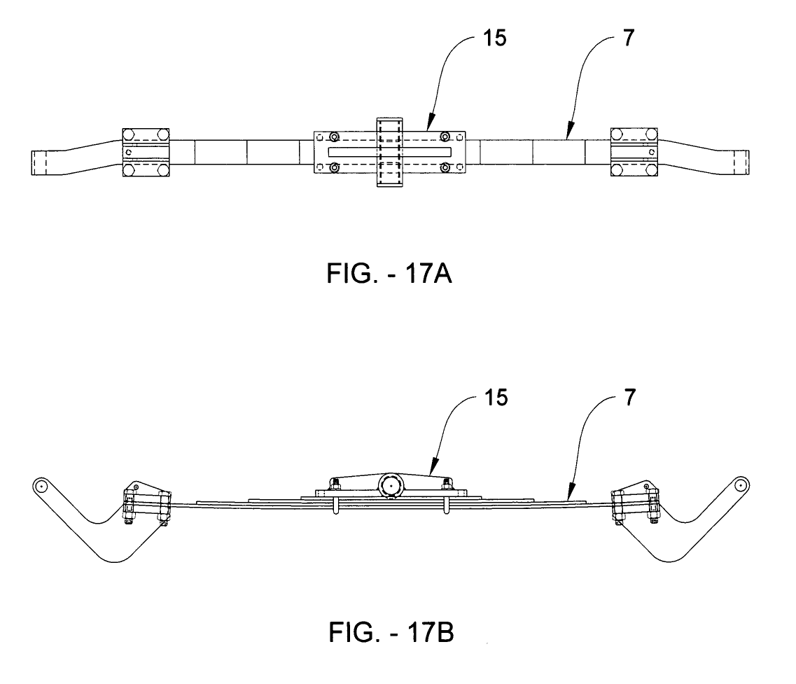

FIG. 17A Top view of leaf spring assembly

FIG. 17B Rear view of leaf spring assembly

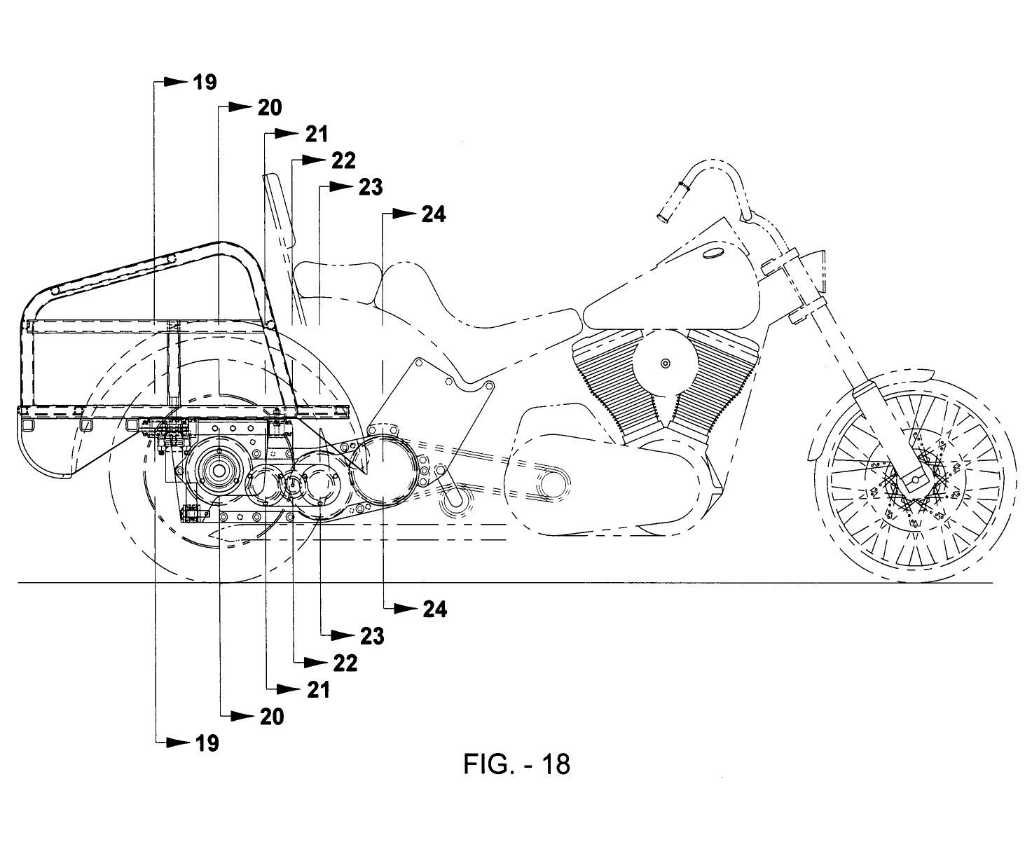

FIG. 18 Side view of present invention

Drawing illustrates cutting plane lines for sections 19-19 thru 24-24

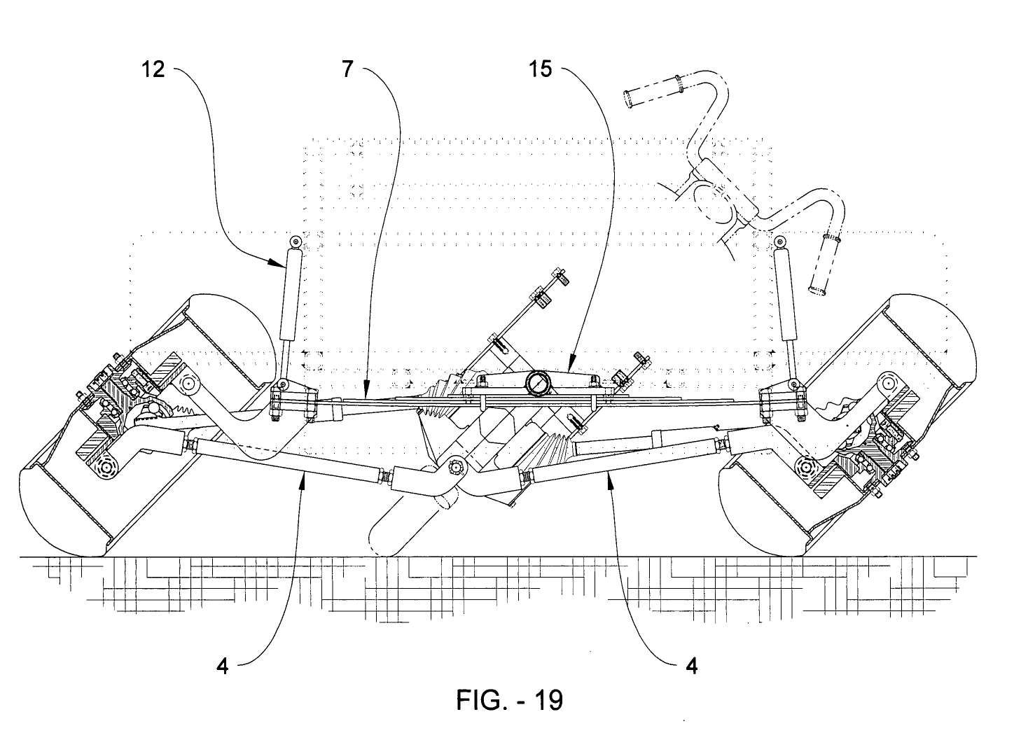

FIG. 19 Section view taken at cutting plane 19-19 (See FIG. 18)

Rear body (5) rotatably connects to leaf spring assembly (7) via bracket (15).

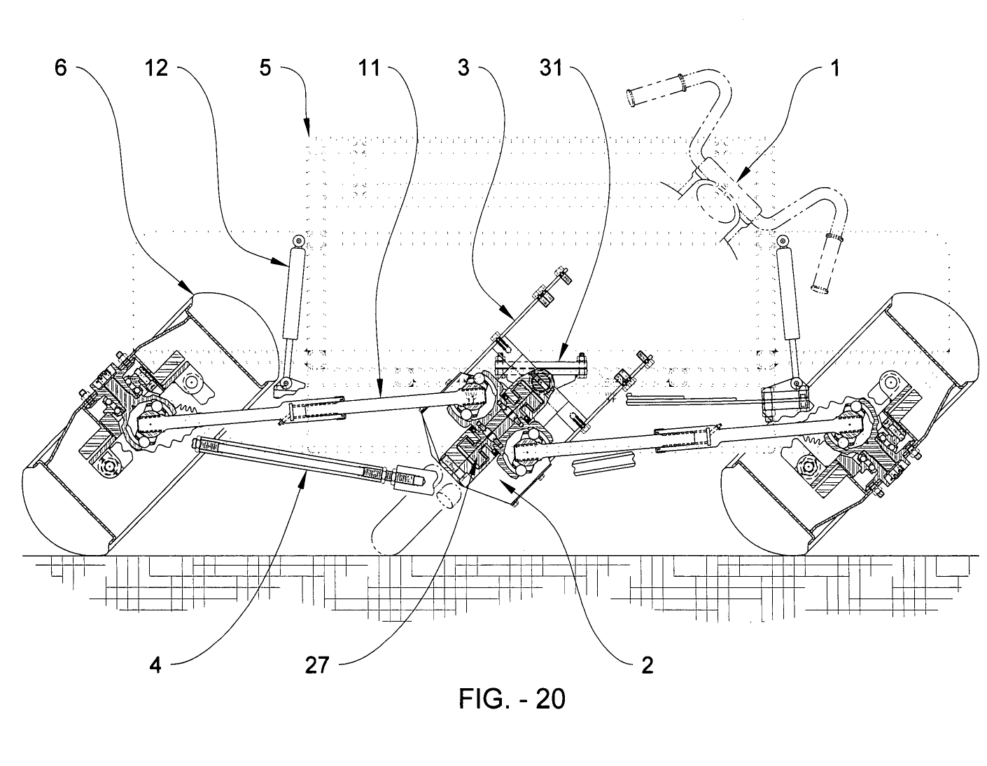

FIG. 20 Section view taken at cutting plane 20-20 (See FIGS. 13 & 18)

Rear body (5) rotatably connects to rear wheel transmission (2) via front mounting bracket (31).

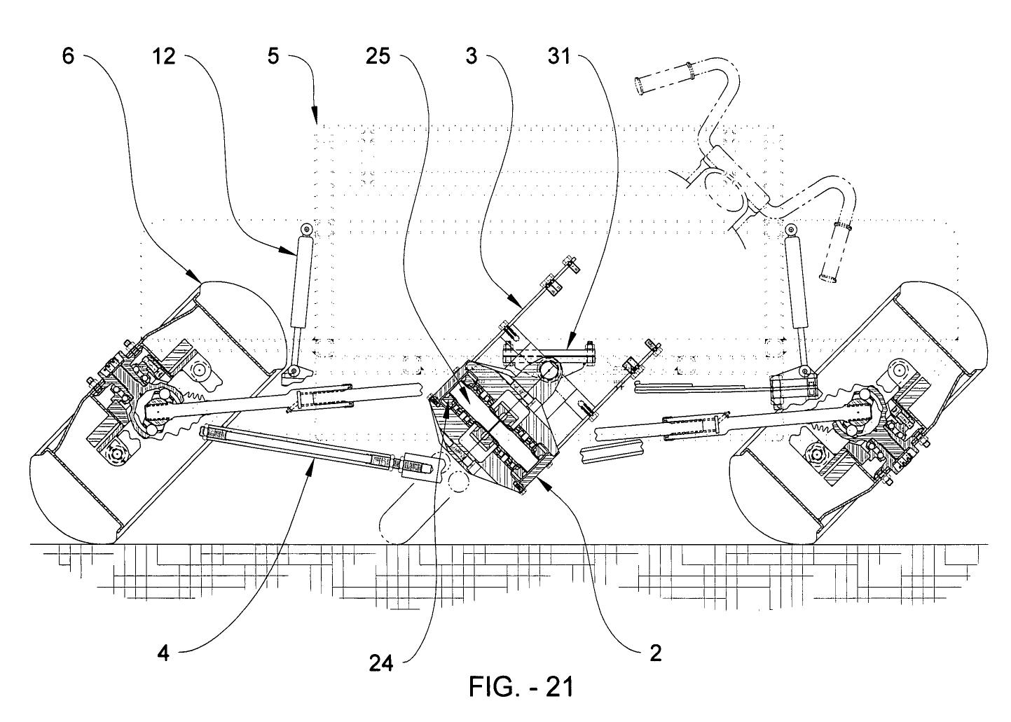

FIG. 21 Section view taken at cutting plane 21-21 (See FIGS. 13 & 18)

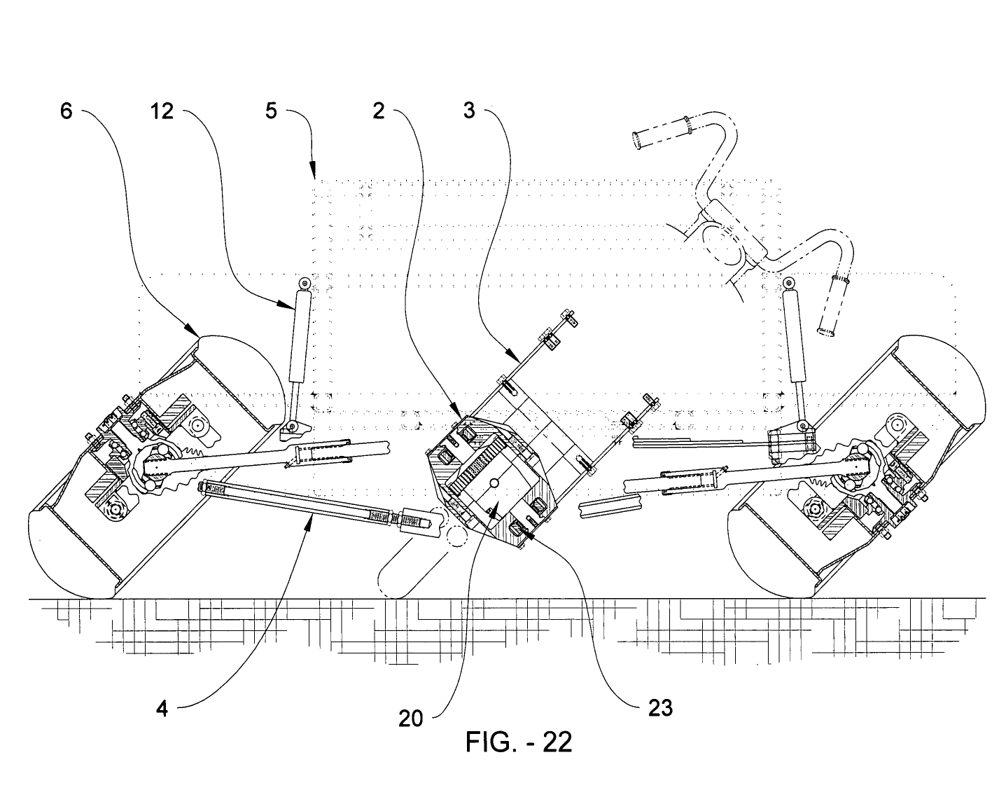

FIG. 22 Section view taken at cutting plane 22-22 (See FIGS. 13 & 18)

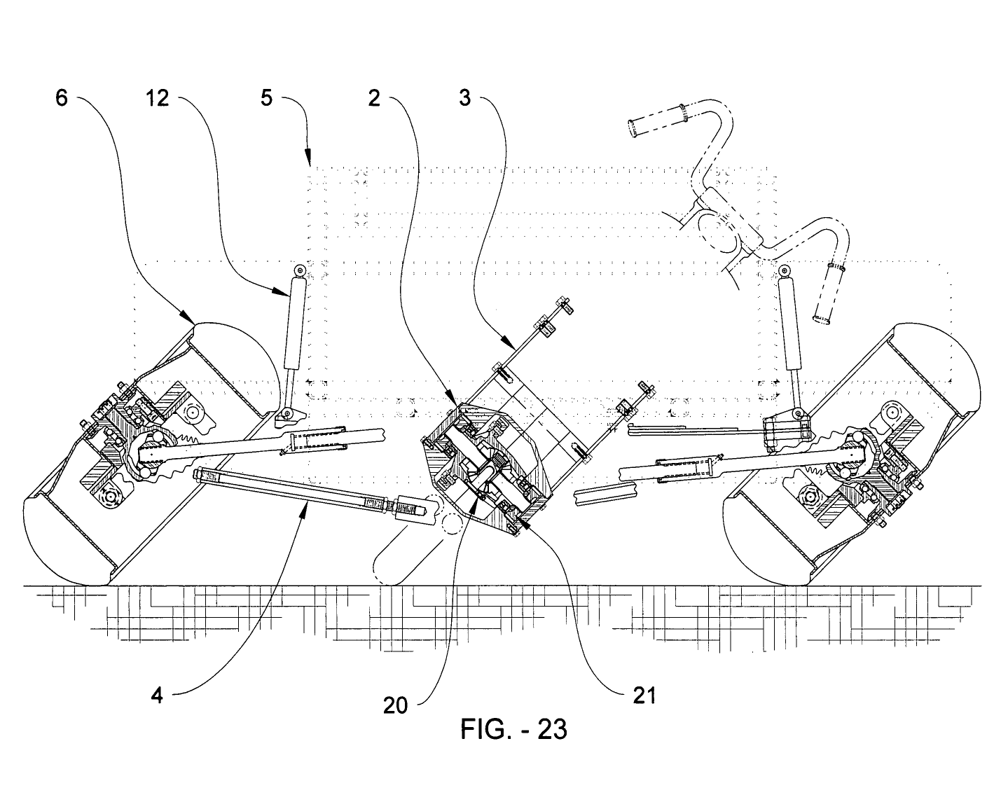

FIG. 23 Section view taken at cutting plane 23-23 (See FIGS. 13 & 18)

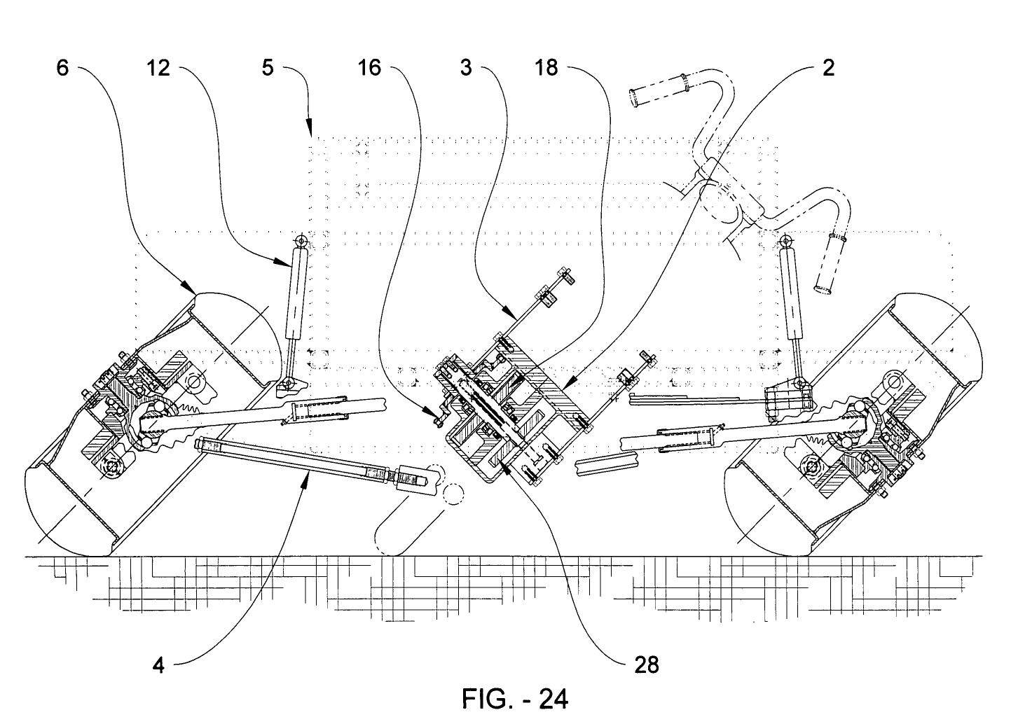

FIG. 24 Section view taken at cutting plane 24-24 (See FIGS. 13 & 18)

What is claimed:

1. An arrangement in which a vertical axis of three wheels remains parallel and steering is accomplished utilizing a phenomenon known as counter steer; wherein a vehicle turns in a direction opposite of a rotation of a steering wheel and handlebar, without the usage of additional sensors or actuators wherein rear body angle remains parallel with roadway surface, independent of wheel and front body angle/lean.

2. An arrangement as defined in claim 1 further comprising:
A drive arrangement which incorporates a differential assembly to allow for a difference in drive wheel speeds in a turn.

3. An arrangement as defined in claim 1 further comprising
A suspension arrangement in which vertical movement of any wheel is independent of other wheels.

4. An arrangement as defined in claim 1 further comprising:
A suspension arrangement in which shock absorbers and brake calipers are incorporated.

5. An arrangement as defined in claim 1 further comprising:
A suspension arrangement in which unit will be self centering upon relaxation of steering input effort.
